(19) United States
(12) Patent Application Publication
(10) Pub. No.: US 2025/0116547 A1
(43) Pub. Date: Apr. 10, 2025

(54) THERMOACOUSTIC SENSOR WITH FLUID MIXING FOR MEASUREMENT OF ACOUSTIC POWER OF ULTRASOUND TRANSDUCERS OVER A WIDEFREQUENCY RANGE

(71) Applicant: THE U.S.A., as represented by the Secretary, Department of Health and Human Services, Silver Spring, MD (US)

(72) Inventors: Matthew R. Myers, Silver Spring, MD (US); Seyed Ahmad Reza Dibaji, Silver Spring, MD (US)

(73) Assignee: THE U.S.A., as represented by the Secretary, Department of Health and Human Services, Silver Spring, MD (US)

(21) Appl. No.: 18/836,317

(22) PCT Filed: Feb. 6, 2023
(86) PCT No.: PCT/US2023/012422

§ 371 Date: Aug. 6, 2024

Related U.S. Application Data
(60) Provisional application No. 63/307,540, filed on Feb. 7, 2022.

(51) Int. Cl. G01H 3/10; G01K 3/06; G01K 13/00

(52) U.S. Cl. CPC G01H 3/10; G01K 3/06; G01K 13/00

(57) ABSTRACT

Ultrasound measurement devices can include a chamber configured to retain an ultrasound detection fluid, wherein the ultrasound detection fluid is configured to absorb an ultrasound beam and to reduce a temperature variation across the chamber during heating by the ultrasound beam, and an acoustic power meter including at least one temperature sensor coupled to the chamber, wherein the temperature sensor is operable to sense a temperature change of the ultrasound detection fluid in response to the heating by the ultrasound beam and the acoustic power meter is configured to estimate a power of the ultrasound beam based on the temperature change.

### CROSS-REFERENCE TO RELATED APPLICATION

This application claims the benefit of the earlier filing date of U.S. Provisional Application No. 63/307,540, filed Feb. 7, 2022, which is incorporated herein by reference in its entirety.

### FIELD

The field is thermoacoustic sensors.

### BACKGROUND

Ultrasound devices have been found to be useful in array of applications for many decades. Therapeutic ultrasound devices have been used for physio-therapy, such as by heating muscles to improve injury recovery and wound healing times. More recently, applications for therapeutic ultrasound have expanded to treat additional medical conditions. Therapeutic ultrasound tends to involve application of higher ultrasound powers to produce the therapeutic effects, and many newer applications can involve a wide range of frequencies, including lower ones. However, measuring ultrasound power transmission can be difficult, particularly at low frequencies. This difficulty presents an obstacle to researchers experimenting with newer ultrasound techniques and doctors and ultrasound technicians maintaining existing ones, who need to more easily measure ultrasound power in order to have reliably calibrated ultrasound equipment. Thus, a need remains for improved sensors and measuring techniques for ultrasound power, particularly over a wide frequency range.

### SUMMARY

According to an aspect of the disclosed technology, ultrasound measurement devices include a chamber configured to retain an ultrasound detection fluid, wherein the ultrasound detection fluid is configured to absorb an ultrasound beam and to reduce a temperature variation across the chamber during heating by the ultrasound beam, and an acoustic power meter including at least one temperature sensor coupled to the chamber, wherein the temperature sensor is operable to sense a temperature change of the ultrasound detection fluid in response to the heating by the ultrasound beam and the acoustic power meter is configured to estimate a power of the ultrasound beam based on the temperature change. In some examples, the chamber includes an inlet aperture configured to receive the ultrasound beam from an ultrasound transducer, and an inlet cover that is transmissive at ultrasound frequencies and that extends across the inlet aperture. Some inlet covers can comprise a thin mylar film. In some examples, the chamber includes an ultrasound scatterer configured to scatter the ultrasound beam to increase an ultrasound absorption in the chamber. In some examples, the scatterer comprises a cone. In selected examples, the chamber has opposing ends with the inlet aperture situated at one of the opposing ends and the scatterer is situated at the other of the opposing ends. In some examples, the chamber includes an ultrasound absorbing interior layer configured to be in contact with the detection fluid. In some examples, the ultrasound absorbing interior layer includes rubber. In some examples, the acoustic power meter includes at least a processor and memory configured with processor-executable instructions that cause the processor to estimate a power of the ultrasound beam based on the temperature change. In further examples, the processor-executable instructions are configured to cause the processor to determine a temperature difference from a signal provided by the at least one temperature sensor and to produce the power estimate from the determined temperature difference and a duration of the ultrasound beam being directed into the chamber to produce the heating of the ultrasound detection fluid. In some examples, the processor-executable instructions are configured to cause the processor to apply a correction to the power estimate based on an energy loss out of the chamber through the cover. In some examples, the at least one temperature sensor comprises a plurality of temperature sensors with each temperature sensor associated with a respective portion of the chamber, wherein the processor-executable instructions are configured to cause the processor to produce the estimate of the power of the ultrasound beam by averaging the temperatures of the portions. In some examples, the processor-executable instructions are configured to cause the processor to apply a correction to the power estimate based on an energy loss out of the chamber through the cover. In some examples, the processor-executable instructions are configured to cause the processor to interpolate or extrapolate ultrasound beam power estimates to produce a power estimate at a different transducer driving level. Some detection fluids can include a mixture of glycerin and water. Some detection fluid mixtures are between 5% and 35% glycerin.

According to another aspect of the disclosed technology, methods of measuring the acoustic power of an ultrasound transducer include coupling an ultrasound transducer to an ultrasound measurement device, wherein the ultrasound measurement device includes a chamber configured to retain an ultrasound detection fluid, wherein the ultrasound detection fluid is configured to absorb an ultrasound beam and to reduce a temperature variation across the chamber during heating by the ultrasound beam, and wherein the ultrasound measurement device includes an acoustic power meter including at least one temperature sensor coupled to the chamber, wherein the temperature sensor is operable to sense a temperature change of the ultrasound detection fluid in response to the heating by the ultrasound beam and the acoustic power meter is configured to estimate a power of the ultrasound beam based on the temperature change, and generating the ultrasound beam with the ultrasound transducer and directing the ultrasound beam into the chamber to estimate the power of the ultrasound beam. In some examples, the chamber includes an inlet aperture configured to receive the ultrasound beam from an ultrasound transducer, and an inlet cover that is transmissive at ultrasound frequencies and that extends across the inlet aperture, wherein the coupling the ultrasound transducer to the ultrasound measurement device includes arranging the chamber such that the inlet aperture is at a low position with the ultrasound transducer directing the beam upward into the chamber through the inlet aperture. Some examples further comprise adjusting driving levels of the ultrasound transducer in response to the estimate.

According to another aspect of the disclosed technology, a computer readable medium is provided that is configured with stored processor-executable instructions for an ultrasound measurement device to estimate a power of an ultrasound beam, wherein the ultrasound measurement device comprises a chamber configured to retain an ultrasound detection fluid, wherein the ultrasound detection fluid is configured to absorb an ultrasound beam and to reduce a temperature variation across the chamber during heating by the ultrasound beam, and wherein the ultrasound measurement device comprises an acoustic power meter including at least one temperature sensor coupled to the chamber, wherein the temperature sensor is operable to sense a temperature change of the ultrasound detection fluid in response to the heating by the ultrasound beam and the acoustic power meter is configured with the processor-executable instructions to estimate the power of the ultrasound beam based on the temperature change.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a side cross-sectional view of an ultrasound power measurement device.

FIG. 2 is a schematic of an ultrasound power measurement device.

FIG. 3 is a flowchart of a method of ultrasound transducer power estimation.

FIG. 4 is a flowchart of a method of ultrasound power estimation power correction.

FIG. 5 is a flowchart of a method of breaking ultrasound power estimation into multiple portions of a detection volume.

FIG. 6 is a flowchart of a method of adjusting ultrasound transducer characteristics in response to power estimations.

FIG. 7A is a photograph of an experimental prototype fluid-based ultrasound power measurement tool.

FIG. 7B is a schematic of the tool pictured in FIG. 7A.

FIGS. 8-9 are graphs of temperature change over time for different transducers of the prototype shown in FIGS. 7A-7B.

FIGS. 10-12 are graphs comparing the estimation performance of the prototype shown in FIGS. 7A-7B with a radiation force balance approach, for different transducers operating at different respective ultrasound frequencies.

FIG. 13 is a schematic of an example computing system in which some described examples can be implemented.

### DETAILED DESCRIPTION

### Introduction to the Disclosed Technology

In many therapeutic ultrasound applications, an ultrasound transducer is positioned in relation to a target tissue so that an ultrasound beam is directed through a coupling medium (such as a gel) to the tissue. When the transducer is operated, the beam transmits through the coupling medium and penetrates the tissue and gradually becomes absorbed. The coupling medium reduces energy loss that can occur due to back reflection off of a medium of very different properties from the incident medium. The absorption of the ultrasound energy within the tissue can depend on various factors, including the composition of the tissue (muscle, fat, etc.), the peak or average power of the beam (e.g., pulsed or continuous-wave operation), and the ultrasound frequency of the beam.

There is often no practical and efficient way to measure ultrasound power emitted by ultrasound transducer instruments operating at lower frequencies or higher powers. Diagnostic tools such as ultrasound imagers typically operate at higher frequencies and/or lower powers, often making related power measurement and calibration equipment for these tools unsuitable for high power therapeutic ultrasound tools. For example, measurement approaches for diagnostic ultrasound tools involving a positioning of a sensor directly in an ultrasound beam path are not advisable at higher beam intensities, owing to the destructive potential of the beam and the likelihood of artifacts. In general, calibration equipment and related approaches that have been used for higher beam powers, such as radiation force-balance, are often difficult or burdensome to employ. Radiation force-balance works by directing an ultrasound beam to a target and power is inferred by the extent to which the ultrasound pushes against the target. However, at longer ultrasound wavelengths (i.e., low frequency operation, which generally includes ultrasound frequencies below around 500 kHz), it becomes more difficult to capture all of the energy that can contribute to the push, increasing inaccuracy. Solid sensors also exist but their temperature is not uniform, and practical ways to increase temperature uniformity in such calorimeters typically require an extensive delay to allow heat to diffuse throughout the solid.

This increased burden leads to fewer calibrations being made, failure to meet specified calibration schedules, or simply avoiding tool calibration altogether. The ease with which disclosed thermoacoustic methods and apparatus can be employed can increase adoption rates of calibration routines and therefore improve the quality and accessibility of therapeutic ultrasound methods. In disclosed thermoacoustic sensor examples, ultrasound beam energy is captured in a fluid filled volume. As the energy is absorbed, the fluid temperature increases, and the free movement of the fluid helps to make the temperature increase more uniform within the volume. In some examples, a cone or other scattering element is situated within the volume to scatter the beam throughout the volume to further distribute energy absorption and improve temperature uniformity.

### Measurement Device Examples

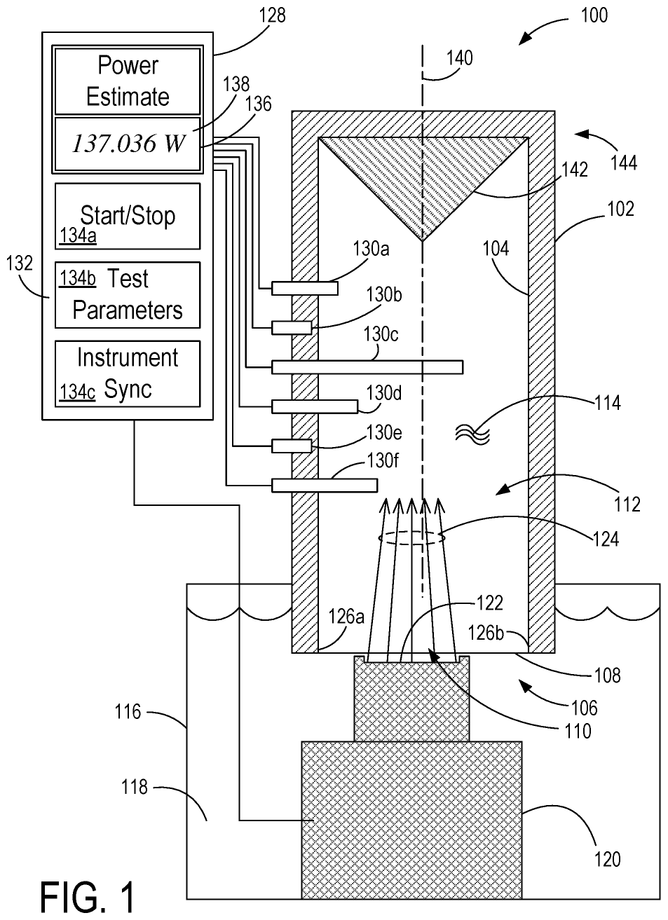

An example ultrasound power measurement device 100 is shown in FIG. 1 in a test configuration. The tool 100 includes a chamber 102 having absorbing surface 104 and a free end 106 enclosed by a cover 108 and defining an input aperture 110. The cover is transmissive to ultrasound energy. The chamber 102 has a volume 112 in which a detection fluid 114 is retained so that the detection fluid 114 can be heated to produce power measurements. In the test configuration, the input aperture 110 faces downward with the free end 106 submerged in a test container 116 filled with degassed water 118. The ultrasound transducer 120 under test can be arranged in the degassed water 118 with a transducer face 122 facing the input aperture 110 and at a selected distance from the input aperture 110. The distance can be selected in relation to the input aperture 110, the diameter of the transducer face 122, and focusing characteristics of the ultrasound beam 124 emitted from the transducer face 122 by the transducer 120 during the test. For example, for larger emitter diameters and focusing beams, the transducer face 122 can be spaced apart from the cover 108 by a sufficient distance such that margins of the ultrasound beam 124 are not clipped by chamber edges 126a, 126b at the input aperture 110 before coupling into the chamber volume 112.

The device 100 includes a controller 128 and at least one, and more typically a plurality of, thermal sensors 130a-130f positioned to sense temperature of the chamber 102. The thermal sensors 130a-130f are coupled to communicate temperature signals to the controller 128, e.g., through wired or wireless communication. The controller 128 can include a user interface 132 having one or more control buttons 134a-134c for controlling different functions of an ultrasound power test and having one or more device displays 136 to display various parameters, such as an ultrasound power estimate 138. Tests can be initiated and/or terminated, e.g., with a start or start/stop control 134a. In many device examples, user device interfaces can be greatly simplified such that additional parameter entries or related interfaces (such as power level, frequency, pulse repetition rate, duty cycle, etc., with test parameter control 134b) are not provided. The absence can provide substantial benefits to user operation given simplicity of operation. However, it will be appreciated that specific examples can include further control over various test parameters,. In some examples, the controller 128 can be coupled to the ultrasound transducer 120 during a power test to control test timing or other parameters of the ultrasound transducer 120 or to monitor transducer values. Metadata associated with one or more tests and/or instruments (e.g., test parameters, power estimates, device identifiers, schedule parameters, etc.) can also be stored by the controller 128 and/or communicated to or between the ultrasound transducer 120 under test.

The thermal sensors 130a-130f are typically thermocouples though other thermal sensors may be used. The thermal sensors 130a-130f can be coupled to the chamber 102 at various positions. For example, the thermal sensors 130a-130f can be distributed along an axis 140 of the chamber 102. During a power measurement of the ultrasound transducer 120, the axis 140 can generally align with a propagation direction of the ultrasound beam 124 entering through the input aperture 110. As shown, the thermal sensors 130a, 130c, 130d, 130f can extend into the chamber volume 112 with respective sensing tips positioned at various distances from the absorbing surface 104, e.g., at different radial distances. The thermal sensors 130b, 130e are embedded within a solid material of the chamber 102, such as a container material or a separate ultrasonically absorptive material coating an interior surface of the chamber 102, such as rubber. In different examples, the container material or the separate absorptive material coating the interior surface of the chamber 102 can correspond to the absorbing surface 104. In some examples, one or more of the thermal sensors 130a-130f can be azimuthally distributed about the axis 140.

Distributed characteristics of the thermal sensors 130a-130f can improve measurement accuracy in various ways, including with respect to variable characteristics of difference ultrasound transducers 120 under test. For example, different ultrasound transducers can have different focusing or propagation characteristics, causing localized temperature gradients in the detection fluid 114. A beam focus situated near one of the temperature sensors 130a-130f can cause a higher temperature reading to occur at that sensor relative to the others. The temperature values of the temperatures sensors 130a-130f can be integrated across the chamber volume 112 to produce a more accurate measurement of power.

In representative examples, a cone 142 or other beam scattering element can be situated at an end 144 opposite the free end 106. As the ultrasound beam 124 propagates through the detection fluid 114, the energy from the ultrasound beam 124 gradually becomes absorbed by the detection fluid and any ultrasonically absorptive material coating an interior surface (if present). However, at higher powers and/or lower frequencies, the ultrasound beam 124 can penetrate deeper into the detection fluid. In some instances, after a single pass through the chamber volume 112, a direct reflection off of a flat back face of the absorbing surface 104, and a return pass through the chamber volume 112, a portion of the energy of the ultrasound beam 124 can exit the chamber volume 112 out the input aperture 110. The cone 142 or other beam scattering element can be situated to cause the ultrasound beam 124 to scatter, increasing propagation path length and interaction with absorbing sides of the absorbing surface 104, thereby ensuring attenuation and absorption of any residual ultrasound energy. The cone 142 can be made of acrylic in some examples, though other suitable scattering materials can be used.

The chamber 102 can be formed of various materials or combinations of materials, including thermally insulating materials and/or thermally conductive materials. In some examples, the chamber 102 can be made into a container using polyvinylchloride (PVC), e.g., using an inexpensive PVC tube as an insulating sidewall member. The detection fluid 114 is typically selected to have sufficient acoustic absorption but also a sufficiently low viscosity to permit fluid movement and mixing to enhance convective transfer of heat generated by absorption of ultrasound energy. This effect allows more uniform temperature measurements to be made across multiple thermal sensors in a shorter amount of time. The effect can also allow for a reduced number of thermal sensors based on the more uniform temperature. Various fluids can be used for the detection fluid 114. In representative examples, a 20%/80% mixture of glycerin and water is used as the detection fluid. Further mixtures can include 5/95, 10/90, 15/85, 25/75, or 30/70 glycerin/water ratios. In further examples, additional materials can be added (including liquids) while maintaining similar glycerin/water ratios or by using other ratios. In some examples, scattering agents can be added to the detection fluid 114 to increase scatter of the incident ultrasound beam 124 under test.

During test operation, the ultrasound beam 124 is directed into the chamber volume 112 through the inlet aperture 110, and the energy of the ultrasound beam 124 is fully absorbed as it propagates throughout the chamber volume 112. The absorption of the energy as the ultrasound beam 124 dissipates produces a corresponding increase in the temperature of the sensor (detection fluid and boundaries) according to conservation of energy principles and the first law of thermodynamics. Thus, with the mass and heat capacity known for all components that are heated, temperature measurements can be used to directly compute a change of energy in the chamber 102. Estimates of the power of the ultrasound beam 124 can then be made based on the duration over which the ultrasound beam 124 was directed into the chamber 102. As mentioned previously, representative examples are configured such that the ultrasound beam 124 is directed upwards into the input aperture 110. In this way, adverse effects associated with cavitation in the absorbing fluid can be avoided as any cavitation bubbles generated float to the end 144 and can assist the cone 142 in scattering the ultrasound beam 124.

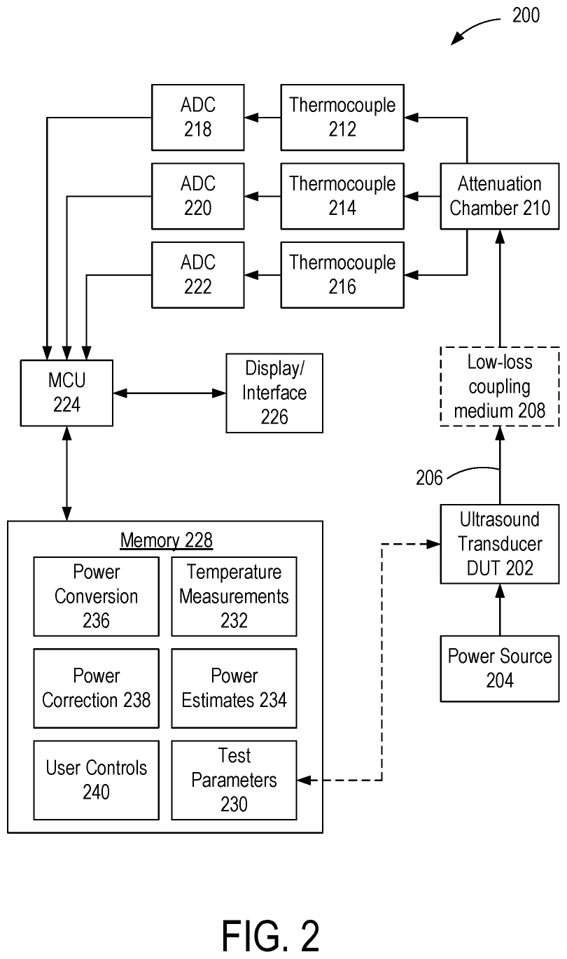

FIG. 2 is an ultrasound power measurement device 200 configured to produce power estimates for an ultrasound transducer device-under-test 202. An electrical power source 204 can be coupled to the ultrasound transducer 202 to supply electrical power for producing an ultrasound beam 206. The beam 206 transmits through a low-loss coupling medium 208 (such as degassed water or an ultrasound gel) to an attenuation chamber 210 storing a detection fluid. The beam 206 increases the temperature of the device as it attenuates completely in the chamber 210. Thermocouples 212, 214, 216 are thermally coupled to the attenuation chamber 210 to detect the increase in temperature caused by the absorption of the ultrasound beam 206. Electrical signals associated with the detected temperature are sent to respective analog-to-digital converters 218, 220, 222 which convert the analog signals to digital signals for receiving by a microcontroller unit (MCU) 224. The MCU 224 can include one or more computing processors configured to estimate ultrasound power, which can be shown on a display/interface 226 in some examples. The MCU 224 is coupled to a memory 228 which can store test parameters 230 of interest to the user, temperature measurements 232, power estimates 234, and other data, along with power estimation routines 236, power correction routines 238, user controls 240, and other software functions and/or modules.

### Example Methods of Ultrasound Transducer Power Measurements

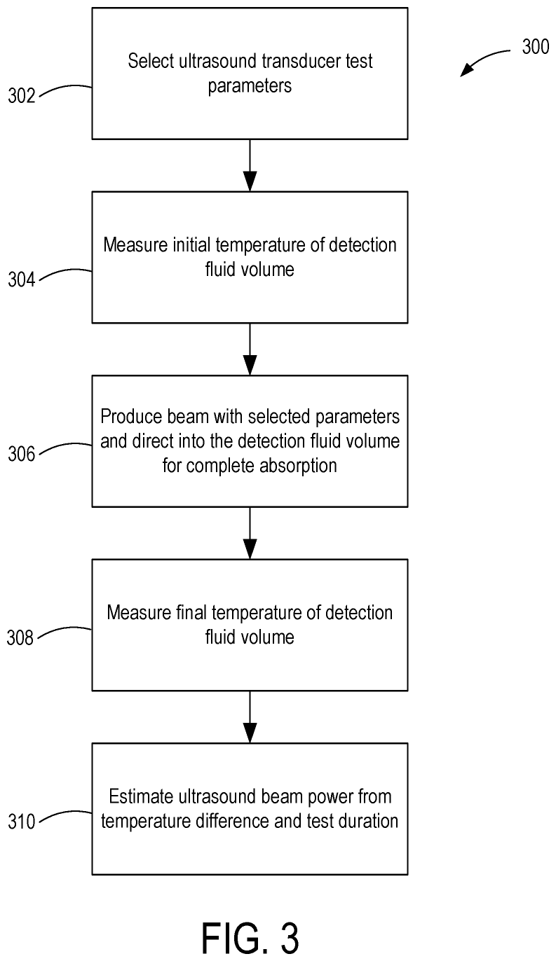

FIG. 3 is an example method 300 of measuring ultrasound transducer power. At 302, a set of test parameters is selected for an ultrasound transducer power test, such as ultrasound frequency and duration. For the selected ultrasound transducer, at 304, an initial temperature of a detection fluid volume is measured, e.g., with one or more thermal sensors thermally coupled to the fluid volume. At 306, an ultrasound test beam is produced and directed into the detection fluid volume for complete absorption therein. For example, a low frequency ultrasound beam can be produced by configuring the ultrasound transducer to emit the beam based on a selected transducer voltage level. At 308, after the duration of the test, the transmission of the ultrasound beam into the detection fluid volume is terminated, e.g., by powering down the transducer or decoupling the beam from the detection fluid volume, and the final temperature of the detection fluid volume is measured. In some examples, the final temperature measurement can be obtained after uncoupling or cessation of the beam so as to allow some time for heat to diffuse to and heat the temperature thermal sensors. At 310, an estimate of the power of the ultrasound beam that was directed into the detection fluid volume can be made by determining the energy increase in the detection fluid volume based on the temperature increase and determining a power over the duration of the test from the determined energy increase.

In representative examples, temperature is measured numerous times (or continuously) over a test duration of operation of the transducer. Having the temperature trace over time can allow computation in various ways. For example, in some examples, estimates can be determined based on an end time, t_{END}, and Power×t_{END}=m×c×ΔT, where m is the mass of the sensor, c is the specific heat, and ΔT is the total temperature rise over time. In further examples, a slope can be used (e.g., the derivative dT/dt) of the temperature vs. time curve (which is very linear) and Power=m×c×dT/dt. Having the temperature vs. time curves for all the thermocouples also can help to determine whether the sensor system is operating correctly. If one thermocouple varies markedly from the others, for example, the thermocouple may need replacement, or the transducer may not be functioning as designed (for example, a phased-array transducer may have an element that is malfunctioning). The temperature can be recorded continuously from an initial time to time t_{END}. The time t_{END} can be chosen to allow for a temperature rise that is significantly above the thermocouple noise level. In representative examples, a delay is not required for heat to diffuse to the thermocouples, since the convective motion of the fluid, and the waves bouncing around the sensor, bring the heat to the thermocouples.

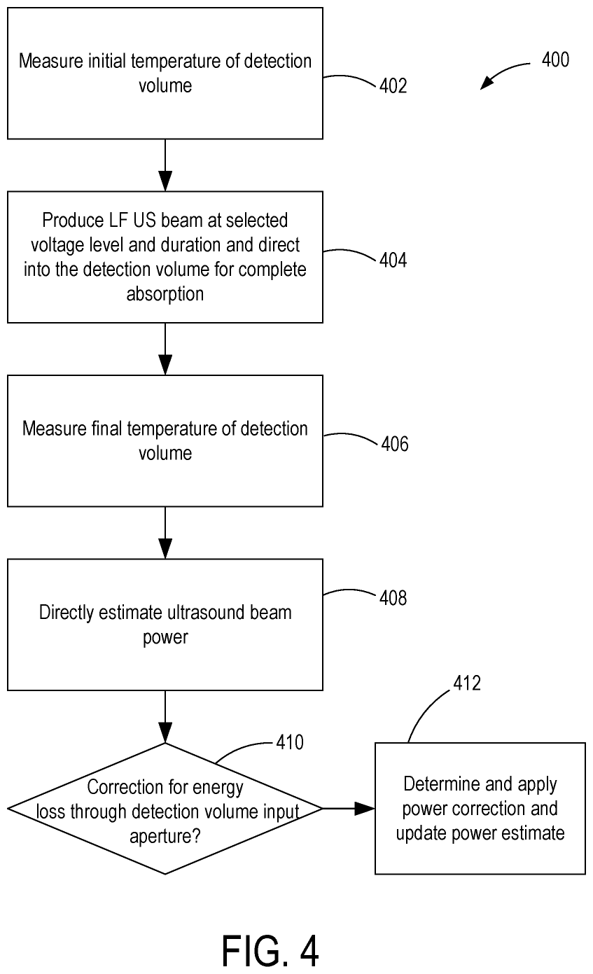

FIG. 4 is an example method 400 of estimating ultrasound transducer power in which a power correction is applied when producing the power estimate. An ultrasound transducer for testing can be selected along with associated test parameters. A power test can commence for the selected transducer by measuring an initial temperature of a detection volume, at 402. The detection volume can include detection fluid, absorbing solid interior members (such as absorptive rubber coatings), and solid casings (such as PVC). At 404, typically simultaneously or shortly after the initial temperature measurement, the test beam is produced by the ultrasound transducer and directed into a power meter detection chamber filled with a detection fluid. For a test duration, the beam continues to emit from the ultrasound transducer and its energy is absorbed completely in the detection chamber. At the end of the test duration, at 406, a final temperature measurement of the detection volume is made. Interim temperature measurements can also be made in some examples. An estimate for the power of the ultrasound beam can be made at 408 by determining a temperature increase in the chamber, determining an energy increase from the temperature change, and determining a power based on the energy increase and the test duration. Measurements can be taken continuously and/or discretely over time. It will be appreciated that the initial and final temperatures can correspond to measurements over a duration of a test as well as measurements between two separate times during a test, such as consecutive times.

The thermal insulating characteristics of the detection chamber generally causes a slow loss of energy to the outside environment. For the duration of the test, the energy loss out highly insulative sides due to the temperature gradient between the heated detection fluid and a room temperature environment is likely to be minimal, owing to the insulating property of air, especially for shorter test durations. Thus, energy loss out highly insulative sides can be corrected for with a very small power correction or effectively ignored. The ultrasound beam is directed into the detection chamber through a cover, such as thin mylar film, that transmits the ultrasound beam with little or no loss. While the beam is completely absorbed within the chamber, energy loss can occur through the cover due to the temperature gradient between the heated detection fluid and the medium in the surrounding environment coupling the transducer to the device (e.g., a degassed water contacting the cover). This loss can be larger than the amount of energy loss through more insulative sides of the chamber. At 410, a check is made to determine whether a power correction is to be applied to a power estimate for the ultrasound beam. For example, power corrections can be made for tests over a selected threshold duration or based on other test parameters or outcomes, such as measured temperature increases, pre-correction power estimates, etc. In some examples, a power correction can be applied to each power estimate irrespective of a threshold condition. At 412, the heat or power correction is applied to the power estimate so that a more accurate power estimate is obtained for the power test of the ultrasound transducer.

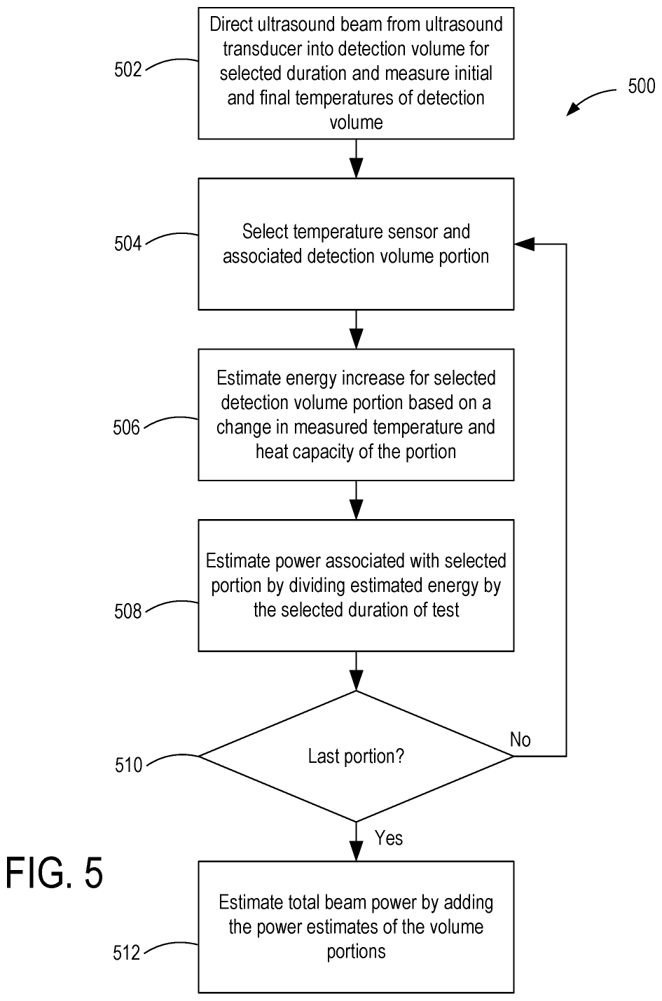

FIG. 5 is an example of a method 500 of estimating ultrasound beam power of an ultrasound transducer by using multiple thermal sensors. At 502, an ultrasound beam from an ultrasound transducer is directed into a detection volume for a selected test duration. Temperatures of the detection volume are measured and recorded at a beginning of the test, e.g., contemporaneous with beam generation, and at an end of the test, e.g., contemporaneous with beam cessation. Temperatures at various times during the test period can also be measured. The detection volume can include multiple temperature sensors coupled to different regions of the detection volume, e.g., at different positions in a detection fluid of the detection volume. Temperature sensors can also be positioned additionally or instead in a thermally conductive and/or ultrasonically absorptive sidewall of the detection volume. The location and number of temperature sensors can be representative of different portions of the detection volume, and corresponding measurements can be used to produce portion estimates for power or energy. The portions can be combined to produce an aggregate power estimate.

For example, at 504, temperature measurements from a temperature sensor associated with a first portion of the detection volume can be selected. At 506, an energy increase in the first detection volume portion can be estimated based on the measured change in temperature and the heat capacity associated with the first detection volume portion. At 508, a power can be estimated for the first detection volume portion by dividing the energy estimate for the first detection volume portion by the test duration. If there are additional detection volume portions to estimate after checking at 510, a similar process of 504, 506, 508 can be performed for the remaining detection volume portions. At 512, a power estimate for the ultrasound beam can be formed by adding the power estimates associated with the plurality of temperature sensors and respectively associated detection volume portions. In some examples, rather than computing individual powers associated with different sections, the temperatures within the smaller volumes are combined (e.g., integrated) to provide an average temperature, and from that average temperature an average power can be computed.

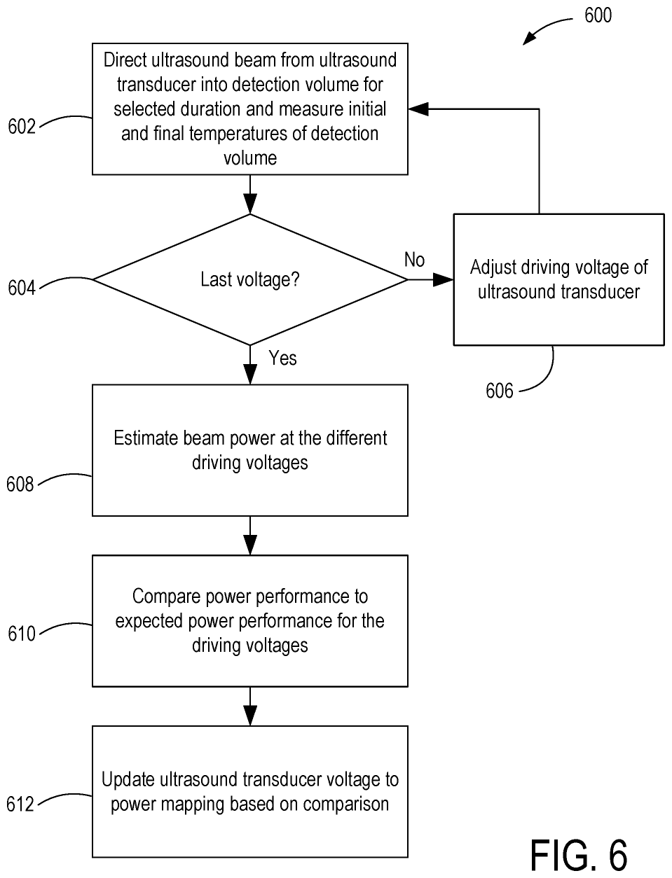

FIG. 6 is an example method 600 of obtaining power estimates over a range of transducer operating levels. At 602, an ultrasound power test can be performed at a selected driving level of an ultrasound transducer, as measured by the transducer driving voltage. The ultrasound beam can be directed from the ultrasound transducer into a detection volume for a selected duration, and initial and final temperatures of the detection volume can be measured. If there are additional driving levels to perform ultrasound transducer tests after checking at 604, the driving level can be adjusted at 606 and the test can be performed again at 602. In some examples, the detection volume can be allowed to cool before retest. In further examples, the test can be performed at elevated temperatures based on use of a temperature difference in the estimation process. At 608, the power of the ultrasound beam can be estimated for the different driving levels, e.g., using any of the disclosed techniques described herein. At 610, the characteristics of the power estimates can define an ultrasound transducer performance, which can be compared against an expected performance for the driving levels. For example, the power estimates over the range of driving voltages can be fitted to a function, such as a quadratic, which can be compared against an expected power profile of an instrument operating normally. At 612, a mapping between driving level and ultrasound transducer power output for the tested transducer can be updated based on the comparison. For example, experiments can be re-performed at driving voltages that do not produce the expected amount of power.

### Experiment Examples

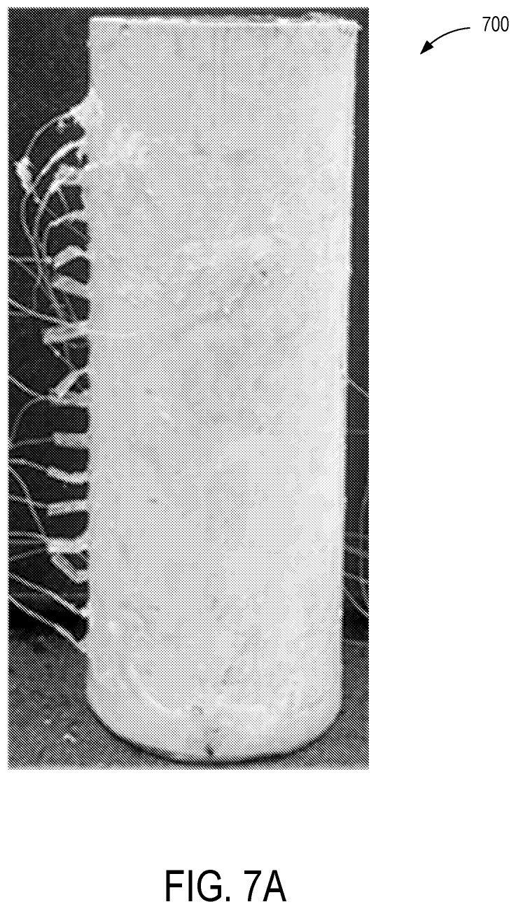

FIG. 7A shows a picture of an experimental prototype thermoacoustic power measurement device 700 configured to be heated by ultrasound energy and FIG. 7B shows a related schematic. The device 700 includes an internal detection volume 702 in which a detection fluid is contained. A container 704 made of PVC tube contains the detection fluid and a rubber layer 706 coats an interior surface of the container 704. Fifteen thermocouples 708a-708o are distributed along the length of the container 704 and are coupled to the detection volume 702 at various positions. Thermocouples 708a, 708d, 708g, 708j, 708m are arranged approximately along a center axis 709 of the container 704. Thermocouples 708b, 708e, 708h, 708k, 708n are embedded within the rubbery layer 706, and thermocouples 708c, 708f, 708i, 708l, 708o are arranged approximately mid-way between the center axis 709 and the rubber layer 706.

An ultrasound acoustic power of a transducer can be inferred from a resulting temperature rise in the internal detection volume 702 of the device 700. A water/glycerin mixture was used as the detection fluid and was separated from a degassed water volume (situated in a tank) by a thin (˜10 micron) Mylar Polyester film 710. During testing the device 700 was in an opposite orientation as shown in FIG. 7B, with a scattering cone 712 at a top position and the film 710 at a bottom position adjacent to the transducer under test. Measurements were performed for a sufficient duration to observe at least a few degrees of temperature rise above thermocouple limits of error. For many power ranges of interest, the time duration for testing may be a few hundred seconds. In some experiments, a duration of 1000 seconds was used, with 250 seconds of cooling time. The user was not required to be involved with the measurement during the acquisition time. The temperature field was observed to be highly uniform (radially and circumferentially) in any given plane in a detection fluid of the device 700.

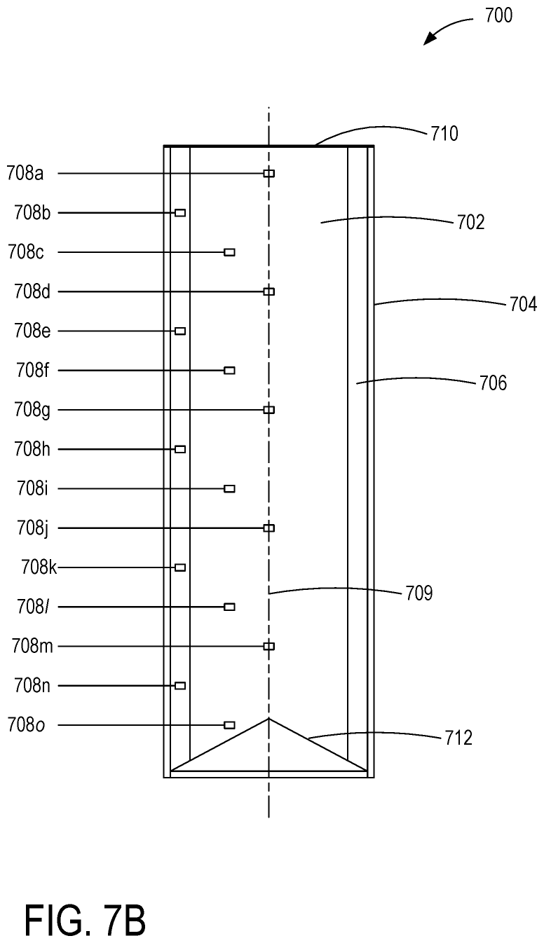

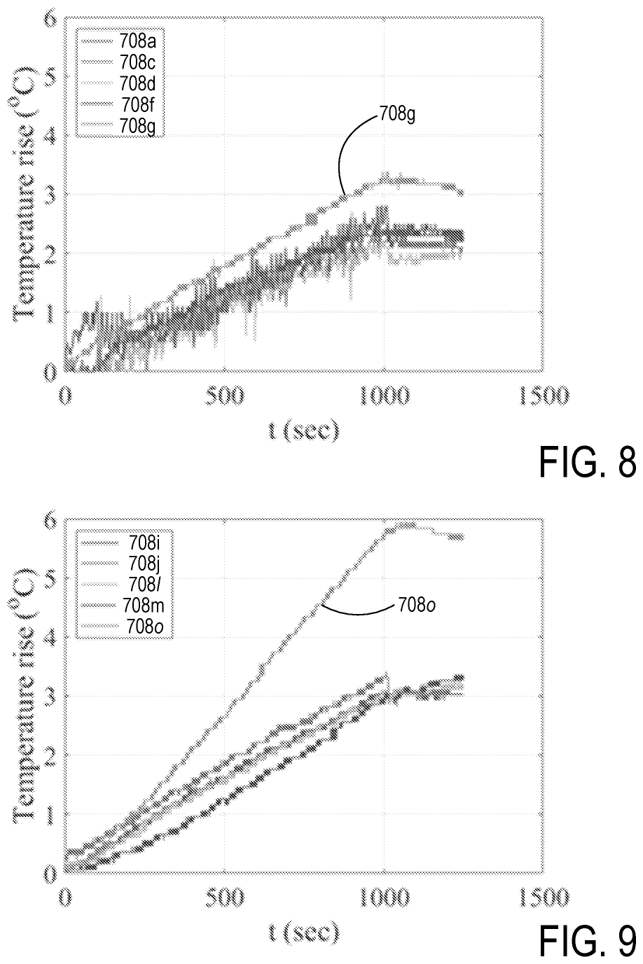

FIG. 8 shows recorded temperatures over 1000 seconds of ultrasound emission and 250 seconds of cooling period for the device 700 as detected by thermocouples 708a, 708c, 708d, 708f, 708g. FIG. 9 shows a similar set of recorded temperatures as detected by thermocouples 708i, 708j, 708l, 708m, 708o. As shown in FIGS. 8-9, there was some variation in temperature observed in the axial direction of axis 709, primarily at a location of the transducer focus, and at the very top near the scattering cone 712. The temperature was observed to be highly uniform at other axial locations within the detection fluid. Axial temperature variations were accounted for in the power calculation by associating the different temperature measurements with different volumetric portions of the detection volume 702.

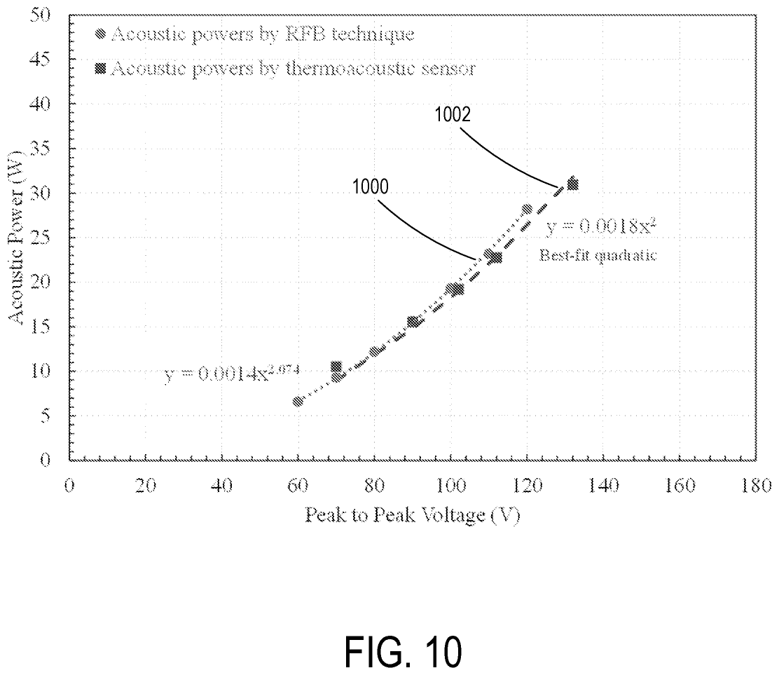

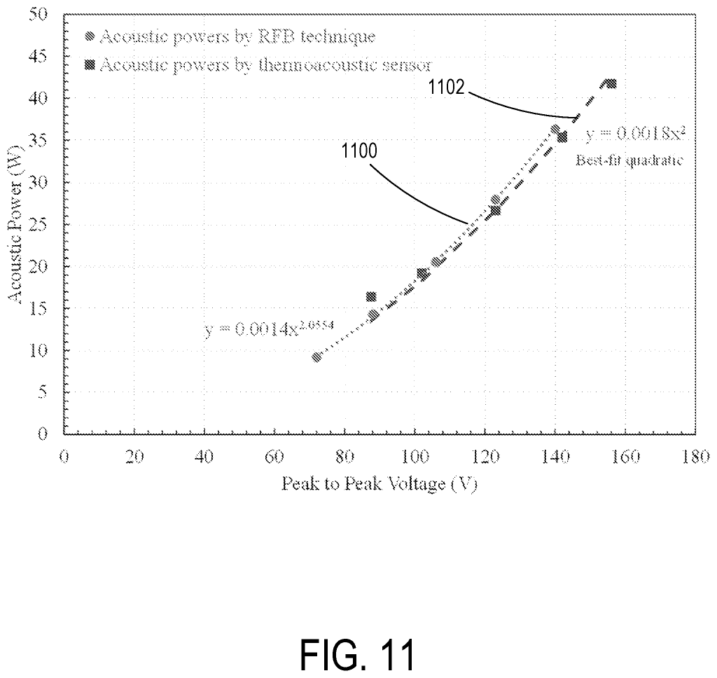

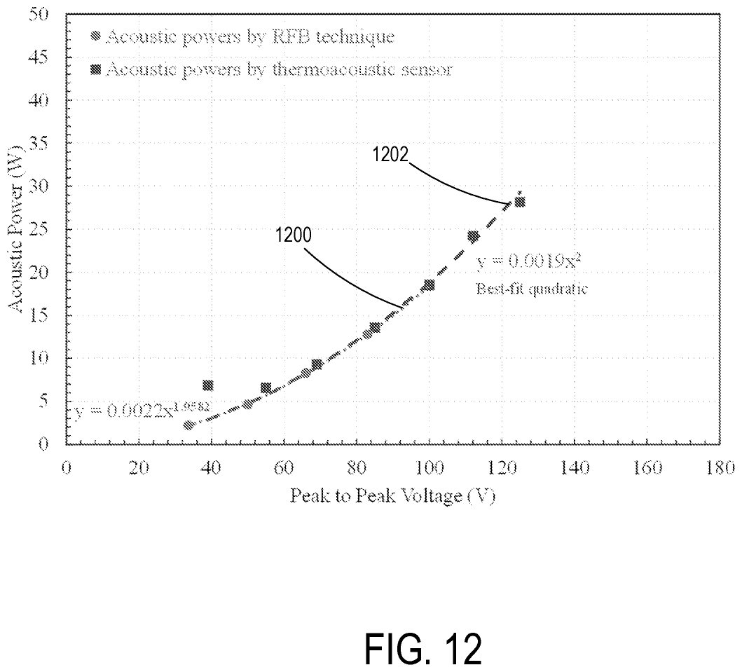

FIGS. 10-12 are graphs comparing transducer powers measured by the thermoacoustic sensor 700 with values obtained from a radiation force balance device. In FIG. 10, lines 1000, 1002 are test results using force radiation force balance and the device 700, respectively, for a transducer H101 operating at an acoustic frequency of 1.18 MHz. Measurements were taken over a range of transducer driving levels, as quantified by peak to peak voltages. FIG. 11 shows test results with lines 1100, 1102 for a transducer H107 operating at a lower frequency of 0.5 MHz. FIG. 12 shows test result lines 1200, 1202 for a transducer H149 operating an acoustic frequency of 0.2 MHz. Overall, there is agreement between the two techniques within about 10% deviation. The variability was higher for the thermoacoustic-sensor technique, but the overall uncertainty is well within an acceptable range for high-intensity ultrasound devices. The thermoacoustic sensor measurements exhibit more variability at low power, which can be due to a lower temperature rise that is closer to the thermocouple limits of error. To reduce measurement variability, measurements can be made at higher driving voltages, and best-fit quadratics (e.g., showing power proportional to the square of the voltage) can be generated and used to interpolate or extrapolate to lower voltages. Notably, at the lowest frequency at which measurements were made (200 kHz), measurements were difficult to obtain using the radiation force balance while there was considerably less difficulty with the thermoacoustic-sensor approach using device 700.

### General Considerations

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

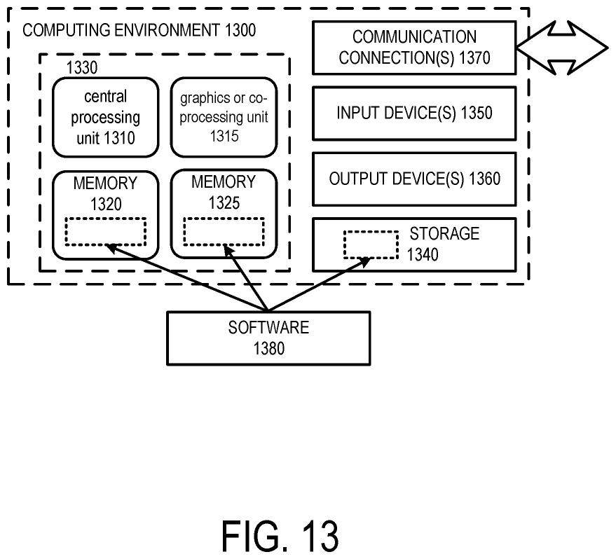

FIG. 13 depicts a generalized example of a suitable computing system 1300 in which the described innovations may be implemented. The computing system 1300 is not intended to suggest any limitation as to scope of use or functionality of the present disclosure, as the innovations may be implemented in diverse general-purpose or special-purpose computing systems.

With reference to FIG. 13, the computing system 1300 includes one or more processing units 1310, 1315 and memory 1320, 1325. In FIG. 13, this basic configuration 1330 is included within a dashed line. The processing units 1310, 1315 execute computer-executable instructions, such as for implementing components of the computing environments of, or providing the data (e.g., temperature sensor data, power estimates, etc.) outputs shown in, FIGS. 1-12, described above. A processing unit can be a general-purpose central processing unit (CPU), processor in an application-specific integrated circuit (ASIC), or any other type of processor. The tangible memory 1320, 1325 may be volatile memory (e.g., registers, cache, RAM), non-volatile memory (e.g., ROM, EEPROM, flash memory, etc.), or some combination of the two, accessible by the processing unit(s) 1310, 1315. The memory 1320, 1325 stores software 1380 implementing one or more innovations described herein, in the form of computer-executable instructions suitable for execution by the processing unit(s) 1310, 1315.

A computing system 1300 may have additional features. For example, the computing system 1300 includes storage 1340, one or more input devices 1350, one or more output devices 1360, and one or more communication connections 1370. An interconnection mechanism (not shown) such as a bus, controller, or network interconnects the components of the computing system 1300. Typically, operating system software (not shown) provides an operating environment for other software executing in the computing system 1300, and coordinates activities of the components of the computing system 1300.

The tangible storage 1340 may be removable or non-removable, and includes magnetic disks, magnetic tapes or cassettes, CD-ROMs, DVDs, or any other medium which can be used to store information in a non-transitory way and which can be accessed within the computing system 1300. The storage 1340 stores instructions for the software 1380 implementing one or more innovations described herein.

The input device(s) 1350 may be a touch input device such as a keyboard, mouse, pen, or trackball, a voice input device, a scanning device, or another device that provides input to the computing system 1300. The output device(s) 1360 may be a display, printer, speaker, CD-writer, or another device that provides output from the computing system 1300.

The communication connection(s) 1370 enable communication over a communication medium to another computing entity, such as between power measurement devices and other computing systems and/or ultrasound transducers or related transducer controllers. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Described algorithms may be, for example, embodied as software or firmware instructions carried out by a digital computer. For instance, any of the disclosed ultrasound power estimation techniques can be performed by one or more a computers or other computing hardware that is part of a ultrasound power measurement tool. The computers can be computer systems comprising one or more processors (processing devices) and tangible, non-transitory computer-readable media (e.g., one or more optical media discs, volatile memory devices (such as DRAM or SRAM), or nonvolatile memory or storage devices (such as hard drives, NVRAM, and solid state drives (e.g., Flash drives)). The one or more processors can execute computer-executable instructions stored on one or more of the tangible, non-transitory computer-readable media, and thereby perform any of the disclosed techniques. For instance, software for performing any of the disclosed embodiments can be stored on the one or more volatile, non-transitory computer-readable media as computer-executable instructions, which when executed by the one or more processors, cause the one or more processors to perform any of the disclosed techniques or subsets of techniques. The results of the computations can be stored in the one or more tangible, non-transitory computer-readable storage media and/or can also be output to the user, for example, by displaying, on a display device, temperature measurements, ultrasound power estimates, and/or ultrasound transducer driving level adjustments.

Having described and illustrated the principles of the disclosed technology with reference to the illustrated embodiments, it will be recognized that the illustrated embodiments can be modified in arrangement and detail without departing from such principles. For instance, elements of the illustrated embodiments shown in software may be implemented in hardware and vice-versa. Also, the technologies from any example can be combined with the technologies described in any one or more of the other examples. It will be appreciated that procedures and functions such as those described with reference to the illustrated examples can be implemented in a single hardware or software module, or separate modules can be provided. The particular arrangements above are provided for convenient illustration, and other arrangements can be used.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim all that comes within the scope of the appended claims.

1. An ultrasound measurement device, comprising:
a chamber configured to retain an ultrasound detection fluid, wherein the ultrasound detection fluid is configured to absorb an ultrasound beam and to reduce a temperature variation across the chamber during heating by the ultrasound beam; and
an acoustic power meter including at least one temperature sensor coupled to the chamber, wherein the temperature sensor is operable to sense a temperature change of the ultrasound detection fluid in response to the heating by the ultrasound beam and the acoustic power meter is configured to estimate a power of the ultrasound beam based on the temperature change.

2. The device of claim 1, wherein the chamber includes:
an inlet aperture configured to receive the ultrasound beam from an ultrasound transducer, and
an inlet cover that is transmissive at ultrasound frequencies and that extends across the inlet aperture.

3. The device of claim 2, wherein the inlet cover comprises a thin mylar film.

4. The device of claim 2, wherein the chamber includes an ultrasound scatterer configured to scatter the ultrasound beam to increase an ultrasound absorption in the chamber.

5. The device of claim 4, wherein the scatterer comprises a cone.

6. The device of claim 4, wherein the chamber has opposing ends with the inlet aperture situated at one of the opposing ends and the scatterer is situated at the other of the opposing ends.

7. The device of claim 1, wherein the chamber includes an ultrasound absorbing interior layer configured to be in contact with the detection fluid.

8. The device of claim 7, wherein the ultrasound absorbing interior layer includes rubber.

9. The device of claim 2, wherein the acoustic power meter includes at least a processor and memory configured with processor-executable instructions that cause the processor to estimate a power of the ultrasound beam based on the temperature change.

10. The device of claim 9, wherein the processor-executable instructions are configured to cause the processor to determine a temperature difference from a signal provided by the at least one temperature sensor and to produce the power estimate from the determined temperature difference and a duration of the ultrasound beam being directed into the chamber to produce the heating of the ultrasound detection fluid.

11. The device of claim 9, wherein the processor-executable instructions are configured to cause the processor to apply a correction to the power estimate based on an energy loss out of the chamber through the cover.

12. The device of claim 9, wherein the at least one temperature sensor comprises a plurality of temperature sensors with each temperature sensor associated with a respective portion of the chamber, wherein the processor-executable instructions are configured to cause the processor to:
produce the estimate of the power of the ultrasound beam by averaging the temperatures of the portions.

13. The device of claim 12, wherein the processor-executable instructions are configured to cause the processor to apply a correction to the power estimate based on an energy loss out of the chamber through the cover.

14. The device of claim 9, wherein the processor-executable instructions are configured to cause the processor to interpolate or extrapolate ultrasound beam power estimates to produce a power estimate at a different transducer driving level.

15. The device of claim 1, wherein the detection fluid includes a mixture of glycerin and water.

16. The device of claim 15, wherein the mixture is between 5% and 35% glycerin.

17. A method of measuring the acoustic power of an ultrasound transducer, comprising:
coupling an ultrasound transducer to an ultrasound measurement device, wherein the ultrasound measurement device includes a chamber configured to retain an ultrasound detection fluid, wherein the ultrasound detection fluid is configured to absorb an ultrasound beam and to reduce a temperature variation across the chamber during heating by the ultrasound beam, and wherein the ultrasound measurement device includes an acoustic power meter including at least one temperature sensor coupled to the chamber, wherein the temperature sensor is operable to sense a temperature change of the ultrasound detection fluid in response to the heating by the ultrasound beam and the acoustic power meter is configured to estimate a power of the ultrasound beam based on the temperature change; and
generating the ultrasound beam with the ultrasound transducer and directing the ultrasound beam into the chamber to estimate the power of the ultrasound beam.

18. The method of claim 17, wherein the chamber includes an inlet aperture configured to receive the ultrasound beam from an ultrasound transducer, and an inlet cover that is transmissive at ultrasound frequencies and that extends across the inlet aperture;
wherein the coupling the ultrasound transducer to the ultrasound measurement device includes arranging the chamber such that the inlet aperture is at a low position with the ultrasound transducer directing the beam upward into the chamber through the inlet aperture.

19. The method of claim 17, further comprising adjusting driving levels of the ultrasound transducer in response to the estimate.

20. A computer readable medium configured with stored processor-executable instructions for an ultrasound measurement device to estimate a power of an ultrasound beam, wherein the ultrasound measurement device comprises a chamber configured to retain an ultrasound detection fluid, wherein the ultrasound detection fluid is configured to absorb an ultrasound beam and to reduce a temperature variation across the chamber during heating by the ultrasound beam, and wherein the ultrasound measurement device comprises an acoustic power meter including at least one temperature sensor coupled to the chamber, wherein the temperature sensor is operable to sense a temperature change of the ultrasound detection fluid in response to the heating by the ultrasound beam and the acoustic power meter is configured with the processor-executable instructions to estimate the power of the ultrasound beam based on the temperature change.
